(19) United States
(12) Patent Application Publication
(10) Pub. No.: US 2023/0230499 A1
(43) Pub. Date: Jul. 20, 2023

(54) METHOD AND KIT PROVIDING A CRAFT EXPERIENCE FOR NOVICE ARTISTS

(71) Applicant: Baubles and Bottles LLC, Salida, CO (US)

(72) Inventors: Harry Hansen, Salida, CO (US); Nicole Hansen, Salida, CO (US)

(21) Appl. No.: 18/095,863

(22) Filed: Jan. 11, 2023

Related U.S. Application Data
(60) Provisional application No. 63/299,774, filed on Jan. 14, 2022.

(51) Int. Cl. G09B 19/00; A44B 11/00

(52) U.S. Cl. CPC G09B 19/003; A44B 11/001

(57) ABSTRACT

There is disclosed a method and kit providing a crafts experience for a novice artist in assembling a customized belt buckle. The kit may comprise a planar frame, a set of dissimilar inlays each preconfigured for mounting to the frame, a set of fasteners, and instructions. The planar frame may include a raised perimeter, an open center, and a frame channel adjacent to at least a portion of the raised perimeter. The frame channel may be recessed below a front edge of the raised perimeter and include one or more mounting holes. The dissimilar inlays may each include a decorative face mountable flush with the front edge of the raised perimeter. Fasteners may be provided for securing the inlays selected to the frame via the one or more mounting holes. The instructions may direct the novice artist on how to assemble the belt buckle and thereby fulfill the crafts experience.

### CROSS REFERENCE TO RELATED APPLICATIONS

This patent application claims priority to U.S. Provisional Application No. 63/299,774 filed on Jan. 14, 2022 and entitled METHOD AND KIT PROVIDING A CRAFT EXPERIENCE FOR NOVICE ARTISTS, the entire contents of Application 63/299,774 being expressly incorporated by reference herein.

### BACKGROUND

Individuals may be inspired to craft their own distinctive jewelry, clothing, ornaments, textiles, or pottery, but lack convenient access to the raw materials, tools, and workspace to manifest their inspiration. In one solution, crafts parlors or jewelry stores may provide sets of raw materials, crafting tools, and table space to inspired patrons for designing and fabricating unique artistic items such as a belt buckle. Raw materials may include metal, fasteners, leather, glue, beads, paint, solder, and other materials. Forming and assembly tools may also be provided by the parlor, such as metal shears, drills, hammers, razor blades, heat guns, brushes, soldering irons, and files. Unfortunately, the inspired patron may not be an artist skilled in cutting, shaping, etching, coloring, heating, and fastening the provided raw materials, and may not be able to envision the necessary component shaping and mechanical interfacing that would result in a refined appearance and functionality.

In another scenario, standard buckle frames and decorative escutcheons may be purchased online, such as a cowboy-style belt buckle and belt. However, the components may not dimensionally match well and may thereby cause an unrefined appearance, or require course shaping, cutting, and drilling tools not readily available to the inspired would-be artist. For example, a flat escutcheon mounted to a buckle frame may result in an overlay appearance and unrefined look. Also, this piecemeal approach requires up-front design, research, and ordering of materials, and may lack the appropriate tools, workspace, and instructions necessary to generate an easeful and spontaneous crafting experience, especially for the novice artist.

Further concerns with the existing crafts parlors and piecemeal online approaches include safety and training: the novice artist may be required to undertake substantial risk in operating a heat gun or soldering iron, or may require substantial training or supervision by store personnel.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an embodiment, there is disclosed a kit for providing a crafts experience to a novice artist in the assembly of a customized belt buckle configurable for attachment to a flexible belt for holding up a pair of trousers. The kit may comprise a planar frame, a set of dissimilar inlays preconfigured for mounting to the frame, an inlay attachment means, and a set of instructions. The planar frame may include a raised perimeter, an open center, and a frame channel adjacent to at least a portion of the raised perimeter for facing outward. The frame channel may be recessed below a front edge of the raised perimeter, and the frame may include one or more mounting holes spaced along and perforating the frame channel.

The set of dissimilar inlays may each include a decorative face and be preconfigured to occupy the channel and mount with the decorative face approximately flush with the front edge of the raised perimeter. Each of the dissimilar inlays may be selectable by the novice artist assembling the buckle and may include an inlay attachment means compatible with the one or more mounting holes. The inlay attachment means may be provided for securing each of the one or more inlays selected from the set of dissimilar inlays to the frame via the one or more mounting holes.

Continuing, the set of instructions may be provided for directing the novice artist on how to assemble the belt buckle and thereby fulfill the crafts experience. The instructions may be written, recorded, or verbally conveyed. The frame may include a belt attachment means for attaching one end of the flexible belt to the frame. The dissimilar inlays within the set may be distinct in design according to one or more of imagery, color, text, and material.

In another embodiment, there is disclosed a kit for providing a crafts experience to a novice artist in the assembly of a customized belt buckle configurable for attachment to a flexible belt for holding up a pair of trousers. The kit may comprise a planar frame, a set of dissimilar inlays preconfigured for mounting to the frame, and a set of instructions. The planar frame may include a raised perimeter, an open center, and a frame channel adjacent to at least a portion of the raised perimeter for facing outward. The frame channel may be recessed below a front edge of the raised perimeter.

The set of dissimilar inlays may each include a decorative face and be preconfigured to occupy the channel and mount with the decorative face slightly recessed below the front edge of the raised perimeter by a peening distance. The dissimilar inlays may be selectable by the novice artist assembling the buckle. The set of instructions may be provided for directing the novice artist on how to assemble the belt buckle and thereby fulfill the crafts experience. The instructions may be written, recorded, or verbally conveyed.

Continuing, the frame may include a belt attachment means for attaching one end of the flexible belt to the frame. The kit may be configured such that an edge of the decorative face is retainable by peening inwardly the front edge of the raised perimeter.

In still another embodiment, there is disclosed a method of assembling a customized belt buckle from a crafts kit by a novice artist, where the belt buckle may be configurable for attachment to a flexible belt for holding up a pair of trousers. The method may comprise providing the crafts kit having a planar frame and a set of dissimilar inlays which each may be preconfigured to nest in the planar frame. The crafts kit may include a fastening means for mounting one or more inlays selected from the set of dissimilar inlays to the planar frame. The crafts kit may also include a set of instructions for fulfilling the crafts experience. The frame may have a raised perimeter, an open center, and a frame channel adjacent to at least a portion of the frame perimeter for facing outward. The frame channel may be recessed below a front edge of the raised perimeter.

The method may further comprise selecting from the set of dissimilar inlays the one or more inlays having a decorative face preferred by the novice artist assembling the buckle. The method may further comprise fitting the selected one or more inlays into the frame channel such that the decorative face mounts approximately flush with the front edge of the raised perimeter. The method may further comprise fastening the one or more fitted inlays to the planar frame according to the set of instructions and using at least one of the following fastening means:
1) riveting rivets or screwing screws through one or more mounting holes in the frame channel and complementary inlay holes of the selected one or more inlays,
2) peening the front edge of the raised perimeter inwardly to retain an edge of the decorative face.

The planar frame may include a belt attachment means for attaching one end of the flexible belt to the frame, and the dissimilar inlays may be distinct in design according to one or more of imagery, color, text, and material.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIGS. 1a-1d illustrate top and side views of a center-bar buckle for providing a crafts experience, in accordance with an embodiment of the present disclosure.

FIGS. 2a-2b illustrate top and side views of a full-face buckle for providing the crafts experience, in accordance with an embodiment of the present disclosure.

FIG. 3a illustrates a perspective view of a planar frame of the full-face buckle for providing the crafts experience, in accordance with an embodiment of the present disclosure.

FIG. 3b illustrates a perspective view of a decorative inlay of the full-face buckle for providing the crafts experience, in accordance with an embodiment of the present disclosure.

FIG. 4 illustrates a perspective view of the assembled full-face buckle for providing the crafts experience, in accordance with an embodiment of the present disclosure.

FIG. 5 illustrates a perspective view of a planar frame and two decorative inlays for the center-bar buckle for providing the crafts experience, in accordance with an embodiment of the present disclosure.

FIG. 6 illustrates a perspective view of the assembled center-bar buckle for providing the crafts experience, in accordance with an embodiment of the present disclosure.

FIG. 7 illustrates a kit for providing the crafts experience, in accordance with an embodiment of the present disclosure.

FIG. 8 illustrates a crafts parlor for utilizing the kit enabling the crafts experience, in accordance with an embodiment of the present disclosure.

FIG. 9 illustrates a method for providing the crafts experience, in accordance with an embodiment of the present disclosure.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

As may be appreciated, based on the disclosure, there exists a need in the art for a kit and a method providing a crafts experience for a novice artist crafting a distinctive and refined belt buckle. Additionally, there exists a need in the art for a parlor-provided crafts experience that is safe, easeful, and spontaneous. Further, there exists a need in the art for a crafts experience that includes a workspace, the appropriate tools, simple instructions, and little supervision.

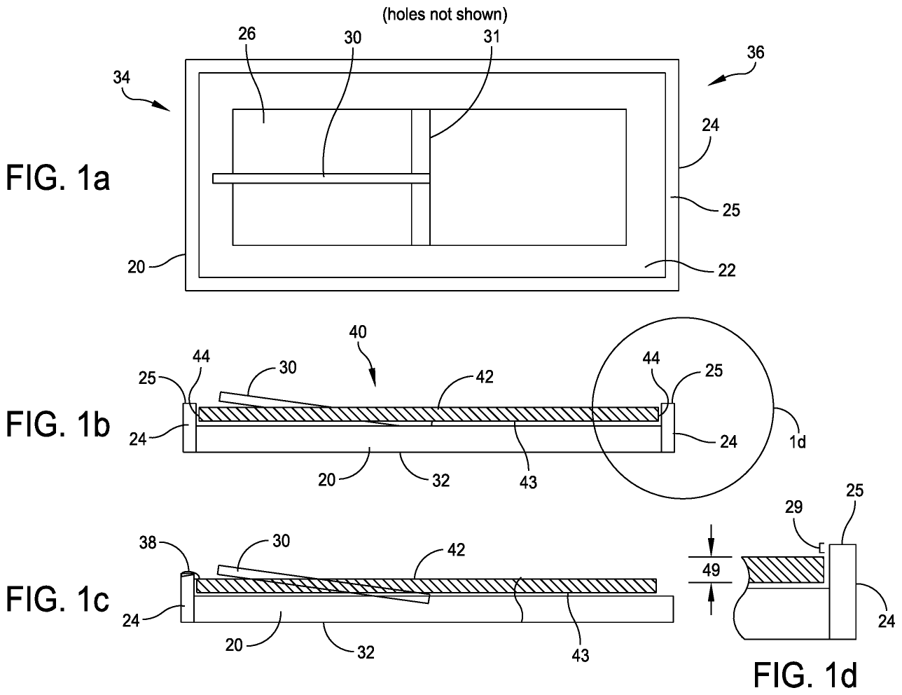

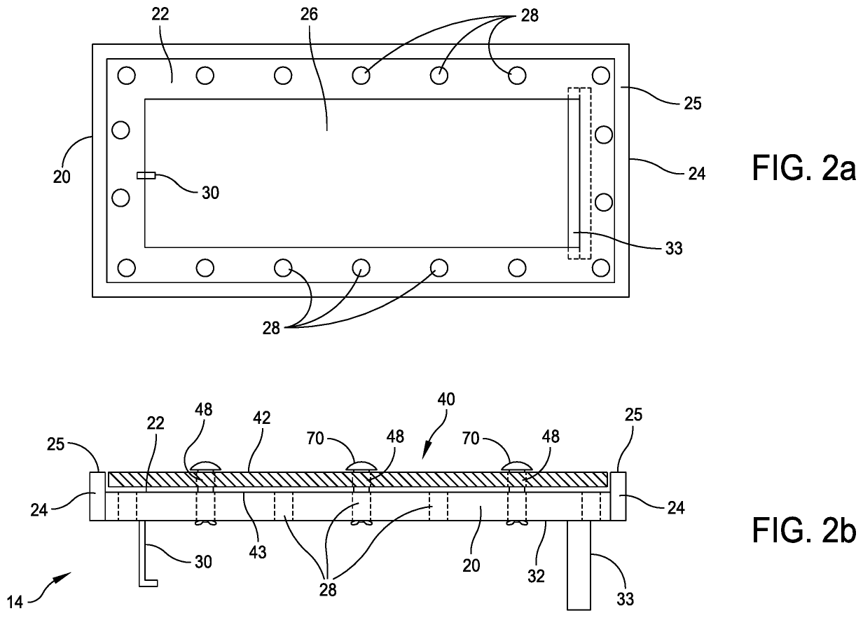

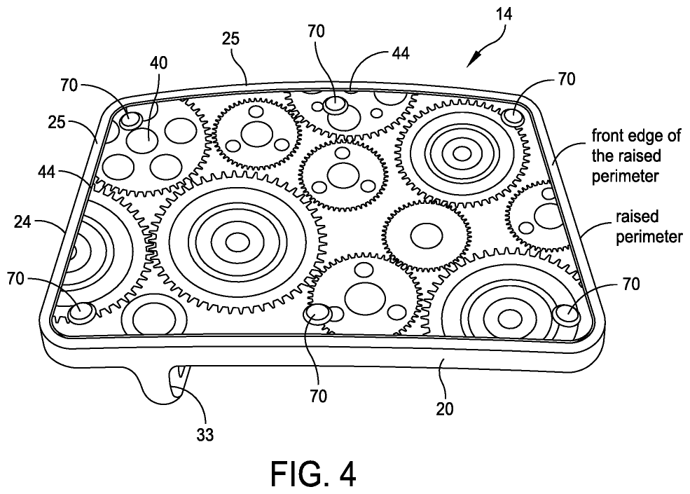

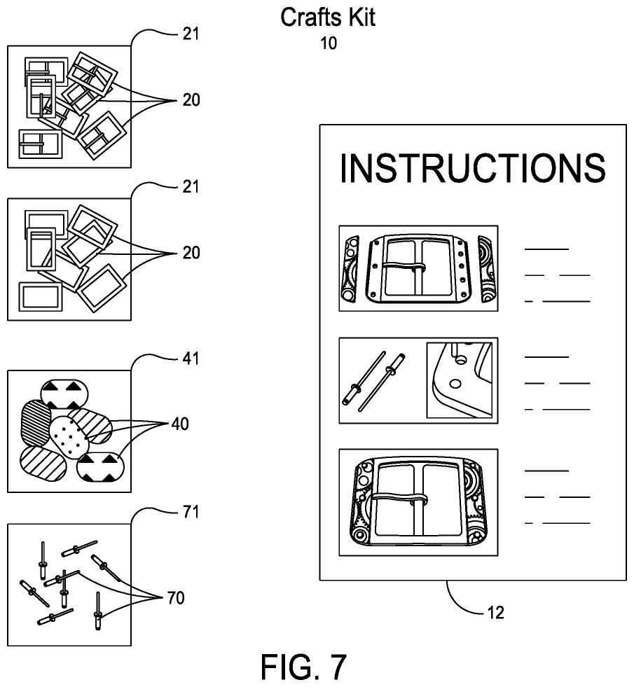

Referring to FIGS. 1a-1d, 2a-2b, 3a-3b, and 4-7, in various embodiments, a kit 10 (FIG. 7) for providing a crafts experience to a novice artist is described for assembling a customized belt buckle 14 (FIGS. 2b, 4, 6). The buckle 14 may be configured for attachment to a flexible belt (not shown) for holding up a pair of trousers, or may stand alone as a decorative buckle. The kit 10 may comprise a planar frame 20 having a raised perimeter 24, an open center 26, and a frame channel 22 adjacent to at least a portion of the raised perimeter 24 for facing outward, the frame channel 22 being recessed below a front edge 25 of the raised perimeter 24.

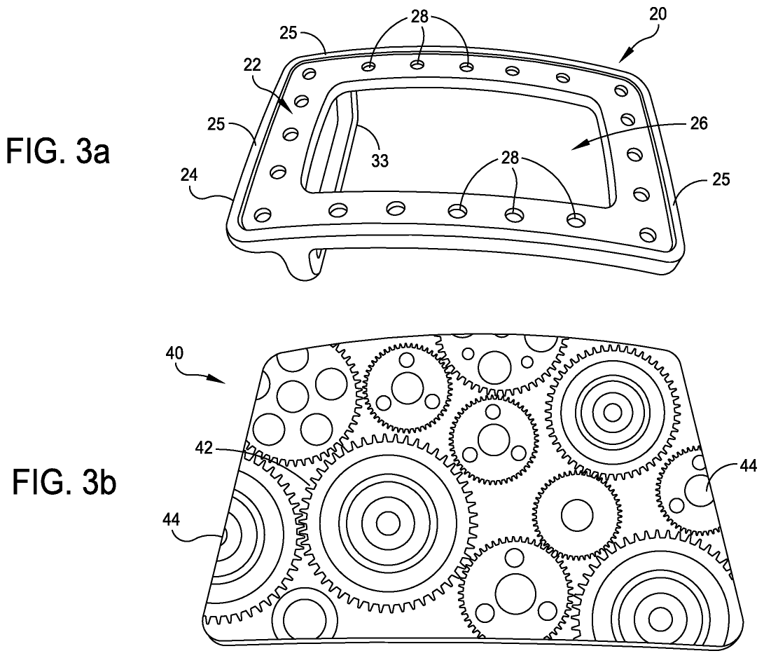

The planar frame 20 may be formed of metal, plastic, wood, composite, or other material. If the belt buckle is worn as a clasping mechanism for the flexible belt, the front edge 25 would be facing forward and away from a waist of a person wearing the belt. Note that FIGS. 1a-1d and 2a-2b may depict simplified versions of the frame 20 as being completely flat, whereas in a preferred embodiment, the planar frame may be approximately flat and may include a slight curvature which is convex forward. For example, the approximately planar frames 20 shown in FIGS. 3a-3b and 4-6 may subtend an arc of less than 25 degrees in order to conform to the curvature of a belted waistline. Alternatively, the curvature of the approximately planar frame 20 may subtend an arc of less than 10 degrees in order to conform to the curvature of a belted waistline, depending on a width of the frame 20 and the waist size of a wearer of the belt buckle 14. The shape of the planar frame 20 may be rectangular (as shown), square, round, oval, or irregular.

Continuing, the planar frame 20 may include one or more mounting holes 28 spaced along and perforating the frame channel 22. As shown in FIGS. 2a-2b, 3a, and 5, the mounting holes 28 may be approximately evenly spaced from each other and from the raised perimeter. In alternative embodiments, the one or more mounting holes may be irregularly spaced and may be configured in any way that facilitates easy assembly and a finished appearance.

The frame 20 may include a belt attachment means for attaching one end of the flexible belt to the frame 20. For example, the belt attachment means may be a belt attachment loop 33 disposed on one side of the frame 20 for securing one end of the belt. The loop 33 may be disposed on a back side 32 of the frame 20 (FIGS. 2a-2b, 3a, and 4), or may be disposed on a left side 34 or a right side 36 of the frame 20 (not shown). Alternatively, the belt attachment means may a circular or oval loop swivelably attachable to the back side of the frame 20. In the case of a center-bar buckle 14, the belt attachment means may be the center bar 31 (FIGS. 1a, 5-6). In the case of a side-bar buckle 14, the belt attachment means may be a side bar (not shown) or may be one side of the frame 20. In alternate embodiments, the frame 20 may be provided without a belt attachment means, and without the attachment loop 33, where the crafted buckle 14 may be intended as a stand-alone ornamental item.

FIGS. 2a-2b depict elements of a full-face, or plate style, buckle and which may have an inward-pointing prong 30 disposed on the back side 32 of the frame 20 for securing the flexible belt through prong holes (not shown) in the belt (not shown). In another embodiment, FIGS. 1a-1d depict a center-bar buckle having a center prong 30 which may mount pivotably to a center bar 31 traversing the frame 20, where the prong 30 may be configured for lying across the open center 26 when the belt is fastened. In both styles, the open center 26 may be configured to allow passage of the belt, to provide for a disposition of the prong 30, or to reduce a weight of the frame 20. Alternatively, the full-face frame (FIGS. 2a-2b) may be closed (lack an open center 26) and the channel 22 may be continuous from the left side 34 to the right side 36 of the frame 20.

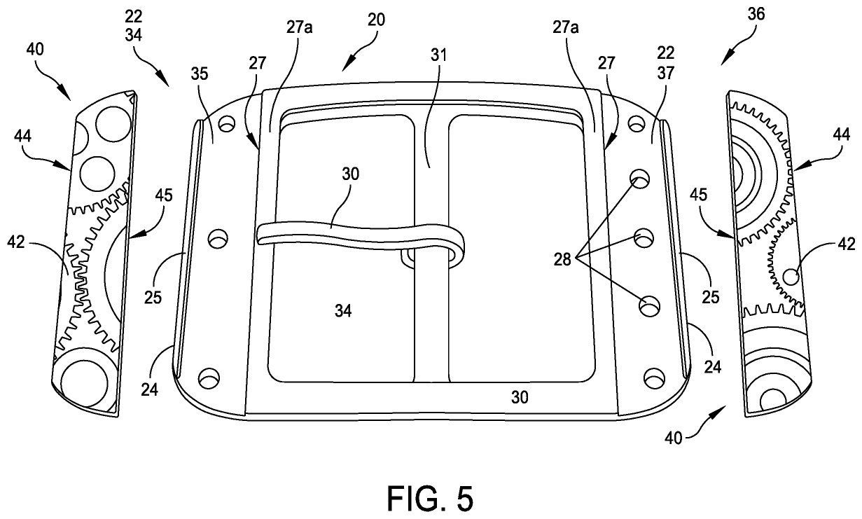

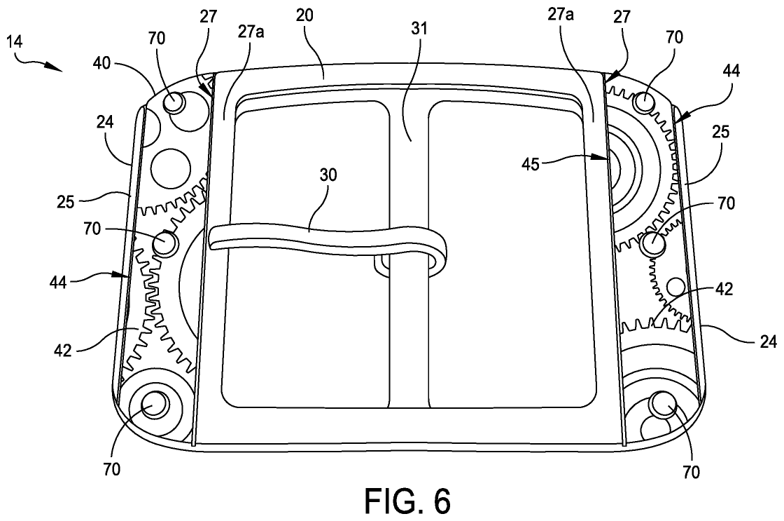

In an embodiment not shown, a side-bar buckle 14 may have the center prong 30 pivotably disposed on the left side 34 or the right side 36 of the frame 20 and may have the frame perimeter 24 raised above the frame channel 22 only on the left and the right side of the planar frame 20, and not on a top and bottom sides of the frame 20. Similarly, as shown in FIGS. 5-6, the frame channel 22 of the center-bar buckle may comprise a left frame channel 35 and a right frame channel 37 and may have the raised perimeter 24 on the left side 34 and the right side 36 of the frame. However, the full-face buckle 14 may include the frame channel 22 bordered by the raised perimeter 24 for 360° around the frame 20 (FIGS. 2a-2b, 3a, and 4).

Returning now to FIGS. 1a-1d, 2a-2b, 3a-3b, and 4-7, in various embodiments, the kit 10 may include a set 41 of dissimilar inlays 40 each having a decorative face 42 and preconfigured to occupy the channel 22. Each of the set 41 of inlays 40 may be selectable by the novice artist and may be configured to mount with the decorative face 42 approximately flush (FIGS. 1b, 2b, 4, and 6) with the front edge 25 of the raised perimeter 24, thereby creating a refined look. The frame channel 22 may be recessed below the front edge 25 of the raised perimeter 24 by approximately a thickness 49 of the selected inlays 40 (FIG. 1d). Each of the inlays 40 (also called ‘inserts’) within the set 41 may interchangeably fit the frame channel 22 and yet may be dissimilar in terms of one or more of the following appearances: imagery, color, text, and material in order. This dissimilarity may provide the novice artist with a personal choice in theme or style for the decorative face 42.

Continuing, in a preferred embodiment, the set 41 of inlays 40 may include many styles or themes, and may include two or more duplicates of each style or theme for assembling a buckle 10 requiring two identical inlays 40. Each inlay 40 within the set 41 may be complementary to one or more frames 20 selectable from the kit 10. The selectable inlay 40 may provide a decorative, customized façade and may be nestable within and supportable by the frame 20 without course cutting or shaping, but may require fine polishing or sanding. The selectable inlay 40 may be formed of metal, leather, plastic, wood, ceramic, or other materials. The selectable inlay 40 may contain text and/or imagery corresponding to a geography, sports, university, wildlife, first name, or other thematic representation.

Still referring to FIGS. 1a-1d, 2a-2b, 3a-3b, and 4-7, in various embodiments, the kit 10 may further comprise an inlay attachment means for securing each of one or more inlays 40 selected from the set 41 of dissimilar inlays 40 to the frame 20 via the one or more mounting holes 28. In one embodiment, the inlay attachment means may comprise one or more inlay holes 48 (FIG. 2b) preconfigured in the one or more selected inlays 40 and alignable with the mounting holes 28 of the frame. The kit 10 may also include a set 71 of fasteners 70 for securing the selected one or more inlays 40 to the frame mounting holes 28 via the one or more inlay holes 48. The set 71 of fasteners 70 may include one or more of a screw, a rivet, a pin, and a bolt.

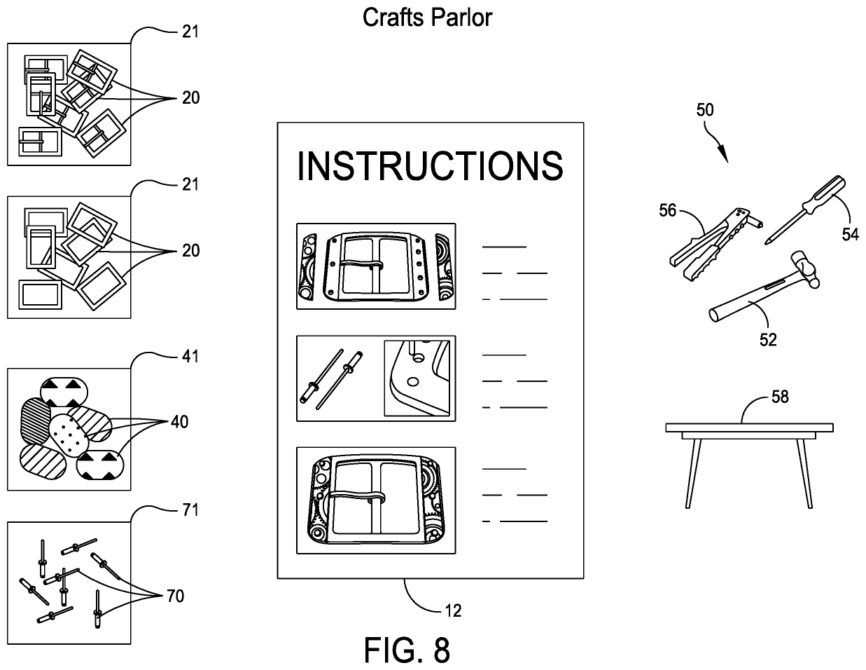

Beneficially, the novice artist may select one or more of the preconfigured and interchangeable inlays 40 from set 41 and may safely fasten the inlays 40 to the frame 20 using unpowered fastening tools 50 such as a hammer 52, a screwdriver 54, or a riveting tool 56 (FIG. 8). The kit 10 may specify one or more of the fastening tools 50 for fastening the one or more selected inlays 40. The kit 10 may also specify one or more of the following assembly tools (not shown) for assembling the belt buckle: a punch, a die, a press, a poker, a scribe, and a hand drill. For a skilled artist, the kit 10 may specify one or more of the following powered assembly tools for assembling the belt buckle: a soldering iron, a heat gun, an electric drill, and a glue gun.

Referring now to FIGS. 3a-3b and 4-6, in another embodiment, the inlay attachment means may comprise a template (not shown) for punching, drilling, poking, or marking a location of the one or more inlay holes 48 in the selected one or more inlays 40, the resulting one or more inlay holes 48 being alignable with the mounting holes 28 in the frame 20. Again, the set 71 of fasteners 70 may be used to fasten the selected inlays 40 to the frame 20 via the resulting inlay holes 48. The template may be the selected frame 20 itself to which the one or more inlays 40 will be fastened, and which may be placed against the selected inlay 40 for punching, drilling, poking, or marking the location of the holes 48 prior to the fastening. Alternatively, the template may be a separate hole template included in the kit 10, and may be a flat piece of metal, paper, plastic, or other suitable material. Beneficially, a skill level of the novice artist may be matched to a method of assembly, and the crafts experience may or may not include forming holes 48 in the inlays 40.

Continuing with FIGS. 3a-3b and 4-6, in further embodiments not shown, the inlay attachment means may comprise specifying or the kit 10 including one or more of the punch, the die, the press, the poker, the scribe, and the hand drill for forming the one or more inlay holes 48 in the selected one or more inlays 40. Alternatively, the inlay attachment means may comprise one or more snap pins (not shown) disposed on a back side 43 of each of the selected one or more inlays 40 and alignable with the mounting holes 28. The snap pins may include an expandable portion at an end of the snap pin having a diameter slightly greater than a diameter of the corresponding mounting holes 28 for retainably snapping the inlay 40 to the frame. Advantageously, preconfiguring the inlays 40 with the one or more snap pins avoids the need for forming inlay holes 48 and may be appropriate for the novice artist not wishing to use the fastening or the assembly tools.

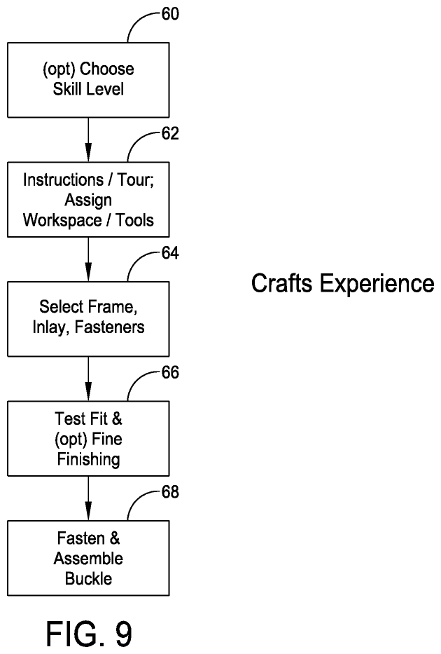

Referring now to FIGS. 7-9, in various embodiments, the crafts kit 10 may include a set of instructions 12 for directing the novice artist how to assemble the belt buckle 14 and thereby fulfill the crafts experience (FIG. 9), where the instructions 12 are written, recorded, or verbally conveyed. The instructions 12 may include labeling (not shown) for component bins for containing one or more of the set 21 of dissimilar frames 20, the set 41 of dissimilar inlays 40, and the set 71 of fasteners 70. The instructions 12 may also include a layout of a crafts parlor (FIG. 8) for fulfilling the crafts experience and which describes placement of the component bins, a workstation 58, and the fastening tools 50. The instructions 12 may further describe steps for assembling the belt buckle 14, instructions for using the fastening tools 50, and/or safety precautions.

Referring now to FIGS. 1b-1d, in another embodiment, as an alternative to using rivets or screws, the kit 10 may comprise the set 41 of dissimilar inlays 40 being preconfigured to occupy the frame channel 22 with the decorative face 42 slightly recessed below the front edge 25 by a peening distance 29 (FIG. 1d). The novice artist may then fasten selected inlays 40 to the frame 20 by peening inwardly the front edge 25 of the raised perimeter 24 over the outer edge 44 of the decorative face 42 of the inlay 40 nested in frame channel 22, thereby creating peened edge 38 for securing the inlay 40 (FIG. 1c). Preferentially, the frame 20 may be fabricated of a deformable material such as a metal, and the instructions 12 may recommend applying a ball-peen to the front edge 25 for securing the inlay 40 to frame 20. The slight recession of the decorative face 42 may be suitable both for fastening by screws and rivets, as in the previously described embodiment, and for fastening by peening the front edge 25.

Continuing with the embodiments shown in FIGS. 1b-1d and 5-6, two like or dissimilar inlays 40 may be selected from the set 41 for occupying the right frame channel 37 and the left frame channel 35 of a center-bar or a side-bar buckle 14. The frame 20 and the two like or dissimilar inlays 40 may be preconfigured such that the decorative faces 42 are slightly recessed below their respective front edges 25 by a peening distance 29 (FIG. 1d). The frame 20 the inlays 40 may also be preconfigured such that decorative faces 42 are slightly recessed below an inner wall 27 of the frame 20 by a peening distance 29. The novice artist may then fasten the two selected inlays 40 to the frame 20 by peening inwardly the front edge 25 of the raised perimeter 24 and peening a top edge 27a of the inner wall 27 over the outer edge 44 and an inner edge 45, respectively, of the decorative faces 42. Alternatively, the inner edge 45 of each of the two decorative inlays 40 may meet the open center 26 of the frame (not shown) for providing a finished appearance without inner walls 27.

Referring to FIGS. 1a-1d, 2a-2b, 3a-3b and 4-9, in various embodiments, a method is described for providing the crafts experience (FIG. 9) to the novice artist assembling the customized belt buckle 14. The method may include providing the crafts kit (FIG. 7-8) having a planar frame 20, a set 41 of dissimilar inlays 40 each preconfigured to nest in the planar frame 20, and a fastening means for mounting one or more inlays 40 selected from the set 41 of dissimilar inlays 40 to the planar frame 20. The method may further comprise providing a set of instructions 12 for assembling the belt buckle 14.

The method may further provide a set 21 of dissimilar frames 20 where at least two frames 20 within the set 21 are dissimilar in terms of one or more of style, shape, and size. The method may also include subdividing the set of dissimilar frames into multiple subsets 21 of frames 20 each containing frames 20 of a particular shape and size. For example, one subset 21 of frames 20 may contain only center-bar buckle frames of a medium size, and another subset 21 of frames 20 may contain full-face frames of a large size.

Referring primarily to FIGS. 7-9, in various embodiments, a patron (novice artist) may enter the crafts parlor (FIG. 8) available to the public, and may select a buckle style (e.g. center-bar) and size (e.g. medium) that they desire to craft. Optionally, the method may include assessing 60 the skill level of the patron and recommending the crafts kits 10 to work with. For example, a simple crafts kit 10 may use screws for assembly, while a kit of higher skill-level may use rivets, or require inlay holes 48 to be drilled in the inlay 40. The method may include supervising or instructing the novice artist in one or more of safety, the riveting or the peening, and the selecting of the inlays. The instructing or supervising may be provided by an agent of the crafts parlor, and may include verbal or textual instructions from the agent. The agent may observe a progress of the novice artist either in person or virtually.

Next, the method may include orienting 62 the patron to the materials and component sets (e.g. frames 20, inlays 40, fasteners 70) available, and may include assigning a workstation 58 and the fastening tools 50. The method may further comprise selecting 64 from the set 41 of dissimilar inlays 40 the one or more inlays having a decorative face 42 preferred by the novice artist assembling the buckle 14. In a preferred embodiment, the inlays 40 in a set 41 may be interchangeable and may differ in imagery, color, text, and material. Within the set 41 of dissimilar inlays 40, the method may provide multiple inlay subsets each for matching a style, shape or size of the provided set 21 of dissimilar frames 20. The method may further comprise fitting 66 the selected one or more inlays 40 into the frame channel 22 such that the decorative face 42 mounts approximately flush with the front edge 25 of the raised perimeter 24. The fitting may include fine finishing the components if necessary. For example, a slight interference fit between the outer edge 44 or the inner edge 45 of the inlay 40 and the raised perimeter 24 or the inner wall 27, respectively, may require sanding or filing.

Continuing with FIGS. 1a-1d, 2a-2b, and 7-9, the method may further include fastening 68 the one or more fitted inlays 40 to the planar frame 20 according to the set of instructions 12 and using at least one of the following fastening means:

1) riveting rivets or screwing screws through the one or more mounting holes 28 in the frame channel 22 and through the complementary inlay holes 48 of the one or more selected inlays 40, or

2) peening the front edge 25 of the raised perimeter 24 inwardly to retain an outer edge 44 of the decorative face 42.

The method may include providing one or more sets 71 of fastening means each comprising rivets or screws and conforming to one size. The set 71 of fasteners may include fasteners 70 that vary in color or material, such as a copper rivet, an aluminum rivet, an anodized or black rivet, a brass screw, and other colors and materials. For example, the novice artist may prefer an aluminum rivet to match a leather inlay, or may prefer a copper rivet to match a copper inlay. Beneficially, since the inlays 40 and frames 20 are preconfigured to match (interchangeable within their particular sets and subsets), assembly of a refined buckle 14 may yield a spontaneous and synergistic experience with little or no supervision from an agent of the crafts parlor.

Referring to FIGS. 7-8, in various embodiments, the kit 10 may include the set 21 of dissimilar frames where at least two frames 20 within the set 21 are dissimilar in terms of one or more of style, shape, and size. In addition, the set 21 of frames 20 may be divided into subsets of frames where each frame 20 within a subset is compatible with a particular size and style of inlay 40 available from set 41. Also, the set 41 of inlays 40 may be divided into multiple inlay subsets each for matching a style, shape or size of the selected frame 20. The set 71 of fasteners 70 may also be divided into multiple subsets of fasteners 70, each of the multiple subsets conforming to one fastener type, one color, and one size. For example, the fastener 70 in one of the subsets may be a rivet formed of brass, steel, aluminum, gold, or plastic, and may be colored or anodized if metallic.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. A kit for providing a crafts experience to a novice artist in the assembly of a customized belt buckle configurable for attachment to a flexible belt for holding up a pair of trousers, the kit comprising:
a planar frame having a raised perimeter, an open center, and a frame channel adjacent to at least a portion of the raised perimeter for facing outward, the frame channel being recessed below a front edge of the raised perimeter, the planar frame including one or more mounting holes spaced along and perforating the frame channel;
a set of dissimilar inlays each having a decorative face and preconfigured to occupy the channel and mount with the decorative face approximately flush with the front edge of the raised perimeter, each of the dissimilar inlays being selectable by the novice artist assembling the buckle;
an inlay attachment means for securing each of one or more inlays selected from the set of dissimilar inlays to the frame via the one or more mounting holes;
a set of instructions for directing the novice artist on how to assemble the belt buckle and thereby fulfill the crafts experience, where the instructions are written, recorded, or verbally conveyed; and
where the frame includes a belt attachment means for attaching one end of the flexible belt to the frame, and where at least two inlays within the set of dissimilar inlays are dissimilar in terms of one or more of imagery, color, text, and material.

2. The kit of claim 1, further comprising:
a set of fasteners for securing the selected one or more inlays to the frame via the inlay attachment means, where the inlay attachment means comprises one or more inlay holes preconfigured in the one or more selected inlays and alignable with the mounting holes of the frame, the set of fasteners including one or more of a screw, a rivet, a pin, and a bolt.

3. The kit of claim 2, further comprising:
the set of fasteners being divided into multiple subsets of fasteners, each of the multiple subsets conforming to one fastener type, one color, and one size.

4. The kit of claim 1, further comprising:
a set of fasteners for securing the selected one or more inlays to the frame via the inlay attachment means, where the inlay attachment means comprises a template for punching, drilling, or marking a location of one or more inlay holes in the selected one or more inlays, the resulting one or more inlay holes alignable with the mounting holes of the frame, the set of fasteners including one or more of a screw, a rivet, a pin, and a bolt.

5. The kit of claim 1, wherein:
a style of the planar frame is one of a center-bar buckle with the raised perimeter present on a left side and a right side of the frame, a side-bar buckle with the raised perimeter on the left and the right side of the frame, and a full-face buckle with the raised perimeter continuous around 360° of the frame.

6. The kit of claim 1, wherein:
the open center of the frame is configured for one or more of a passage of the belt, a disposition of a prong for securing the belt, and reducing a weight of the buckle.

7. The kit of claim 1, wherein:
the belt attachment means is a loop of metal on one side of the frame for securing one end of the belt.

8. The kit of claim 1, further comprising:
a prong disposed on the frame for securing the belt via regularly spaced prong holes in the belt, the prong either projecting inwardly from a back side of the frame or mounting pivotably to the frame for lying across the open center when the belt is fastened.

9. The kit of claim 1, further comprising:
one or more of the following fastening tools for fastening the one or more selected inlays to the frame: a hammer, a screwdriver, a riveting tool.

10. The kit of claim 1, wherein:
the kit is configured for use in a crafts parlor available to the novice artist and containing one or more of a workstation, simple fastening tools, and supervision by an agent of the crafts parlor.

11. A kit for providing a crafts experience to a novice artist in the assembly of a customized belt buckle configurable for attachment to a flexible belt for holding up a pair of trousers, the kit comprising:
a planar frame having a raised perimeter, an open center, and a frame channel adjacent to at least a portion of the raised perimeter for facing outward, the frame channel being recessed below a front edge of the raised perimeter;
a set of dissimilar inlays each having a decorative face and preconfigured to occupy the channel and mount with the decorative face slightly recessed below the front edge of the raised perimeter by a peening distance, where the dissimilar inlays are selectable by the novice artist assembling the buckle;
a set of instructions for directing the novice artist how to assemble the belt buckle and thereby fulfill the crafts experience, where the instructions are written, recorded, or verbally conveyed; and
where the frame includes a belt attachment means for attaching one end of the flexible belt to the frame, and where the kit is configured such that an edge of the decorative face is retainable by peening inwardly the front edge of the raised perimeter.

12. The kit of claim 11, wherein:
a style of the planar frame is one of a center-bar buckle with the raised perimeter present on a left side and a right side of the frame, a side-bar buckle with the raised perimeter on the left and the right side of the frame, and a full-face buckle with the raised perimeter continuous around 360° of the frame.

13. The kit of claim 11, wherein:
at least two inlays within the set of dissimilar inlays interchangeably fit the frame channel and are dissimilar in terms of one or more of the following appearances: imagery, color, text, and material.

14. The kit of claim 11, wherein:
the open center of the frame is configured for one or more of a passage of the belt, a disposition of a prong for securing the belt, and reducing a weight of the buckle.

15. The kit of claim 11, further comprising:
one or more of the following fastening tools for fastening the one or more selected inlays to the frame: a hammer, a screwdriver, a rivet tool.

16. A method of assembling a customized belt buckle from a crafts kit by a novice artist, the belt buckle configurable for attachment to a flexible belt for holding up a pair of trousers, the method comprising:
providing the crafts kit having a planar frame, a set of dissimilar inlays each preconfigured to nest in the planar frame, a fastening means for mounting one or more inlays selected from the set of dissimilar inlays to the planar frame, and a set of instructions for assembling the belt buckle, the frame having a raised perimeter, an open center, and a frame channel adjacent to at least a portion of the frame perimeter for facing outward, the frame channel being recessed below a front edge of the raised perimeter;
selecting from the set of dissimilar inlays the one or more inlays having a decorative face preferred by the novice artist assembling the buckle;
fitting the selected one or more inlays into the frame channel such that the decorative face mounts approximately flush with the front edge of the raised perimeter;
fastening the one or more fitted inlays to the planar frame according to the set of instructions and using at least one of the following fastening means:
1) riveting rivets or screwing screws through one or more mounting holes in the frame channel and complementary inlay holes of the selected one or more inlays,
2) peening the front edge of the raised perimeter inwardly to retain an edge of the decorative face; and
where the planar frame includes a belt attachment means for attaching one end of the flexible belt to the frame, and where the dissimilar inlays are distinct in design according to one or more of imagery, color, text, and material.

17. The method of claim 16, further comprising:
providing a set of dissimilar frames where at least two frames within the set are dissimilar in terms of one or more of style, shape, and size.

18. The method of claim 17, further comprising:
within the set of dissimilar inlays, providing multiple inlay subsets each preconfigured for matching at least one of the style, the shape, and the size of one of the at least two frames within the set of dissimilar frames.

19. The method of claim 16, further comprising:
providing one or more sets of fastening means each comprising rivets or screws and conforming to one size.

20. The method of claim 16, further comprising:
supervising the novice artist in one or more of safety, the riveting or the peening, and the selecting of the inlays.
